(19) United States
(12) Patent Application Publication
(10) Pub. No.: US 2007/0267494 A1
(43) Pub. Date: Nov. 22, 2007

(54) MOBILE TERMINAL INCORPORATING CARD REMOVAL MECHANISM

(75) Inventors: Woo-Sun Kang, Gyeonggi-Do (KR); Han-Seok Chae, Seoul (KR); Soo-Hyun Nam, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/749,640

(22) Filed: May 16, 2007

(30) Foreign Application Priority Data
May 18, 2006 (KR) 10-2006-0044723
Oct. 23, 2006 (KR) 10-2006-0103168

(51) Int. Cl. G06K 7/06

(52) U.S. Cl. 235/441

(57) ABSTRACT

A mobile terminal incorporates a card removal unit having an elastic member in a battery mounting part formed on a rear surface of the terminal. A card is inserted into a card receiving part formed on one side of the battery mounting part contacting the elastic member. When the battery is inserted into the battery mounting part, one edge of the battery contacts the card and the card compresses the elastic member. The battery retains the card in the card receiving part when the battery is secured. When the battery is removed, the elastic member urges the card partially from the card receiving part thereby easing manual removal of the card. A locking rod may be provided to retain the card in the card receiving part when the battery is removed.

### CROSS-REFERENCE TO RELATED APPLICATIONS

This non-provisional application claims priority under 35 U.S.C. § 119(a) on Patent Application Nos. 10-2006-0044723 and 10-2006-0103168 filed in Korea on May 18, 2006 and Oct. 23, 2006 respectively, the entire contents of which are hereby incorporated by reference.

### FIELD OF THE INVENTION

The present invention relates to a mobile terminal with a detachable external card and, more particularly, to a mobile terminal with an external card which can be easily separated from a terminal body.

### DESCRIPTION OF THE RELATED ART

Currently, mobile terminals provide diverse functions such as receiving a satellite broadcast, capturing images and playing games, etc. In order to operate such functions smoothly, mobile terminals have a detachable external memory in addition to a fixed internal memory, and terminals with a detachable external memory increasingly are being used.

Besides an external memory, the use of a Subscriber Identification Module (SIM) card storing personal banking settlement information for use as a credit card, a traffic card and a pre-paid card is also increasing.

In the related art, a card mounting part is formed in a terminal body into which the card is detachably inserted. The card mounting part is commonly formed in a battery receiving part where a battery is mounted. When the card is mounted in the card mounting part, the SIM card is connected with the terminal body and transmits and receives data to and from the terminal body.

However, the card mounting structure of the mobile terminal according to the related art has the following problems. The card is difficult to separate from the terminal body, and to insert into or to remove the card from the terminal body may require sufficient force to damage the card.

### SUMMARY OF THE INVENTION

Therefore, in order to address the above matters the various features described herein have been conceived. One aspect of the invention is to provide a mobile terminal adapted to facilitate removing a card such that the card is drawn out of a card receiving part when a battery is separated from a battery mounting part.

This invention provides a mobile terminal that includes a battery mounting part formed on a rear surface of a terminal body receiving a battery, a card receiving part formed on one side of the battery mounting part receiving a card, and a card removal unit installed on one side of the card receiving part wherein the card removal unit urges the card from the receiving unit when the battery is removed from the battery mounting part.

Another aspect of the invention is to provide locking unit installed on one side of the terminal body securing the card in the card receiving part. The locking unit has a locking rod slidably mounted on one wall surface of the battery mounting part wherein the locking rod is in one of a closed position and an open position; and a spring urging the locking rod in a closed position. The locking rod has a slope portion for urging the locking rod into the open position when the card is inserted into the card receiving unit, and a protrusion for manually moving the locking rod into the open position.

Still another aspect of the invention provides a battery mounting part formed on a rear surface of a terminal body receiving a battery, a card receiving part formed on one side of the battery mounting part receiving a card, and a button unit mounted on one side of the battery mounting part urging the card from the card receiving part. One end of a withdrawing member contacts with a rear surface of the button unit, the other end of the withdrawing member contacts with the rear surface of the card, and a central portion of the withdrawing member is hinge-connected to an inner surface of the terminal body.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view of a mobile terminal according to one aspect of the present invention.

FIG. 2 is a perspective view of a card receiving part of the mobile terminal according to one aspect of the present invention.

FIG. 3 is a perspective view showing a state in which a card is inserted into a card receiving part according to one aspect of the present invention.

FIG. 4 is a sectional view of a mobile terminal according to a second aspect of the present invention.

FIG. 5 shows an operational state of the mobile terminal according to the second aspect of the present invention.

FIG. 6 is a sectional view of a mobile terminal according to a third aspect of the present invention.

FIG. 7 shows an operational state of the mobile terminal according to the third aspect of the present invention.

### DETAILED DESCRIPTION OF THE INVENTION

The mobile terminal according one aspect of the present invention will now be described with reference to the accompanying drawings.

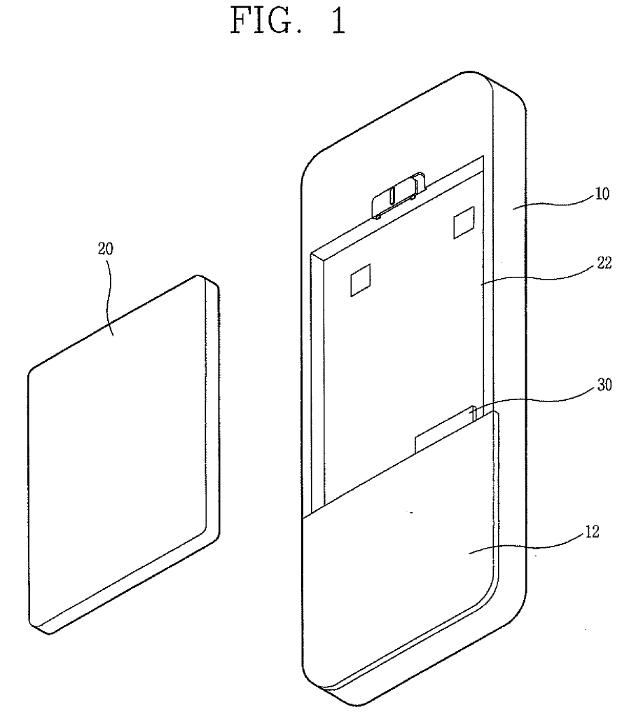

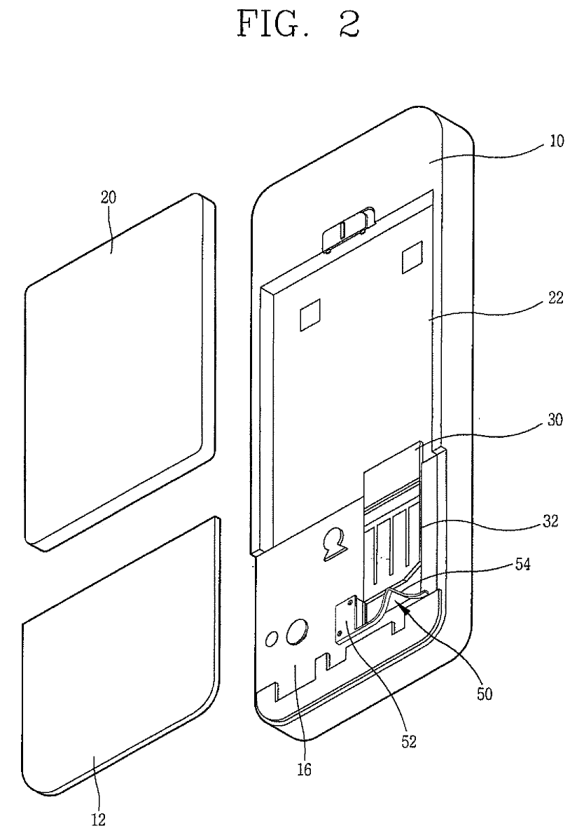

FIG. 1 is an exploded perspective view of a terminal, and FIG. 2 is a perspective view of a card receiving part.

The terminal includes: a terminal body 10, a keypad (not shown) installed on a front surface of the terminal body 10; a battery 20 mounted on a rear surface of the terminal body 10; and a display unit (not shown).

The terminal body 10 includes an antenna and a printed circuit board (PCB) in which a communication module is electrically connected with the antenna to transmit and receive signals.

The display unit can be mounted on the front surface of the terminal body 10 or mounted on a different body mounted at the terminal body such that it can be opened and closed.

On the rear surface of the terminal 10, a battery mounting part 22 is formed into which the battery 20 is detachably mounted. A card receiving part 32 is formed on one side of the battery mounting part 22, into which a card 30 is detachably received.

A portion of the rear surface of the terminal body 10 is opened to allow the battery 20 to be mounted. The other remaining portion of the rear surface of the terminal body 10 is covered by a rear cover 12. The PCB 16 on which various components are mounted is installed in the portion covered by the rear cover 12, and the card receiving part 32 for receiving the card 30 is formed on one side of the PCB 16.

The battery 20 is slidably mounted on the battery mounting part 22; the battery 20 is mounted on the battery mounting part 22 and then pushed in the upward direction and locked in place.

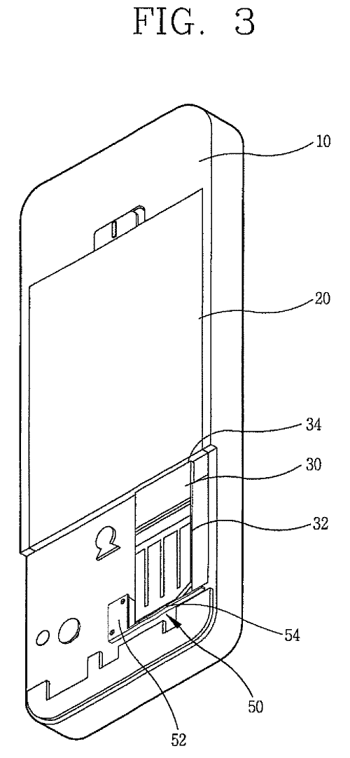

The card receiving part 32 forms a receiving space when covered by the rear cover 12. An entrance 34 (FIG. 3) of the card receiving part 32 through which the card 30 is inserted and removed is formed at an upper side wall of the battery mounting part 32.

The card receiving part 32 is formed in the lengthwise direction of the terminal body, so the card is drawn out or inserted in the lengthwise direction of the terminal body. Accordingly, the card 30 is drawn out toward the battery mounting part 22 from the card receiving part 32.

A card removal unit 50 is mounted at the card receiving part 32 so that when the battery 20 is separated from the battery mounting part 22, the card 30 in the card receiving part 32 is drawn out of the card receiving part 32. The card 30 may store a user's personal banking settlement information and can be a SIM card used as, for example, a non-contact type electronic credit card, a traffic card, or a pre-paid card. The card 30 may also be an external memory card or a game card

In one aspect of the invention, the card removal unit 50 is formed as an elastic member mounted within the card receiving part 32 and provides an elastic force in the direction that the card 30 is withdrawn. Namely, when the battery 20 is separated from the battery mounting part 22, the elastic member 50 urges the card 30 out of the card receiving part 32.

In this case, the card 30 is urged from the entrance 34 of the card receiving part 32 a distance that allows the user to easily remove the card 30, and but does not allow the card to be released completely from the card mounting part when the battery is separated.

Preferably, the elastic member is a plate spring.

The card removal unit 50 includes a fixed part 52 fixed on one side of the terminal body 10 and an elastic member 54 formed in a plate type spring integrally extending from the fixed part 52 and having a concavely protruded central portion to generate an elastic force when contacting with the side of the card 30.

The card removal unit 50 is formed as the elastic member as described above, but without being so limited; it may have any structure so long as it can urge the card 30 from the card receiving part 32 when the battery 20 is removed from the battery mounting part 22.

The card removal operation of the mobile terminal according to a first aspect of the present invention will now be described. FIG. 3 is a perspective view of a card 30 received in a card receiving part 32 according to the first aspect of the present invention.

First, when the card 30 is inserted into the card receiving part 32, it can be inserted until the card 30 contacts the elastic member 54. Next, the battery 20 is inserted into the battery mounting part 22. The upper surface of the battery 20 pushes the rear surface of the card 30, and accordingly, the card 30 is inserted further into the card receiving part 32 thereby compressing the elastic member 54.

When the card 30 is to be removed, the battery 20 is removed from the battery mounting part 22. With the battery 20 removed, the compressed elastic member 54 urges the card 30 a certain distance from the entrance 34 of the card receiving part. Then the user can conveniently withdraw the card from the card receiving part 32.

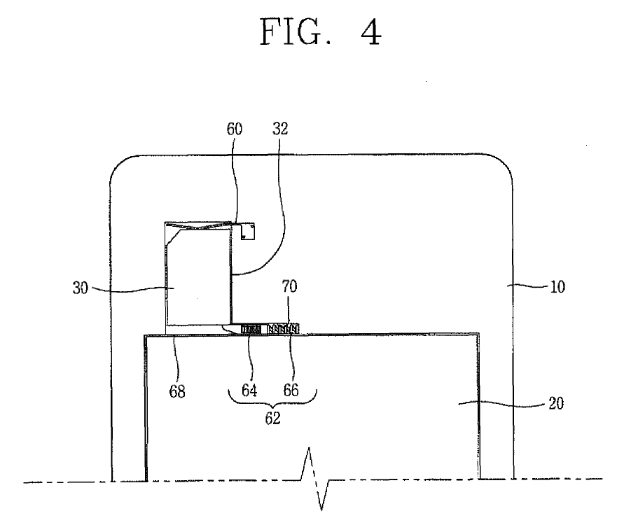

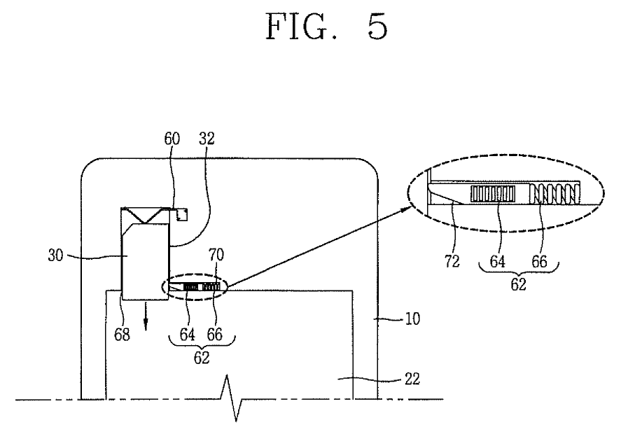

FIG. 4 is a sectional view of a mobile terminal according to a second aspect of the present invention, and FIG. 5 shows an operational state of the mobile terminal according to the second aspect.

The mobile terminal according to the second aspect includes a terminal body 10 having a battery mounting part 22 into which the battery 20 is detachably mounted, a card receiving part 32 formed on one side of the battery mounting part 22 for receiving a card, an elastic member 60 that provides an elastic force to urge the card from the receiving part 32, and a locking unit 62 for securing the card 30 in the card receiving part 32.

The card 30, the card receiving part 32 and the elastic member 60 of the mobile terminal according to the second aspect of the present invention are located at the same positions as the first aspect. The locking unit 62 secures the card 30 when the card 30 is fully inserted into the card receiving part 32.

The locking unit 62 includes a locking rod 64 slidably mounted to in a widthwise direction of the terminal 10 in one wall surface of the battery mounting part 22 and opening and closing an entrance 68 of the card receiving part 32, and a spring 66 providing an urging force to the locking rod 64 and closing the entrance 68 of the card receiving part 32. A guide groove 70 in which the locking rod 64 is inserted is formed on one wall surface of the battery mounting part 22. The locking rod 64 is linearly moved at a right angle to a direction in which the card 30 is received.

A protrusion is formed on one surface of the locking rod 64 to allow the user to move the locking rod 64, and a slope face 72 is formed at an end portion of the locking rod 64 so that when the card 30 is inserted in the card receiving part 32, the locking rod 64 is moved against the force of spring 66.

The operation of the mobile terminal according to the second aspect of the present invention will now be described. The card 30 is inserted into the card receiving part 32 and contacts slope face 72 of locking rod 64. The locking rod 64 is forced by the contact of the card 30 against the force of the spring 66. As the card 30 is fully inserted into the card receiving part 32, the locking rod 64 is disengaged from the card 30. The urging force of the spring 66 then forces the locking rod 64 across the entrance 68 thereby securing the card 30 in the card receiving part 32.

When the card 30 is to be removed from the card receiving part 32, the battery 20 first is separated from the battery mounting part 22 exposing the entrance 68 of the card receiving part 32. The locking rod 64 is moved to the retract position against the compressive force of the spring 66 thereby freeing the card 30 from the card receiving part 32. The card 30 is urged from the card receiving part 32 by the elastic member 60 to a distance where the use can easily complete removing the card 30.

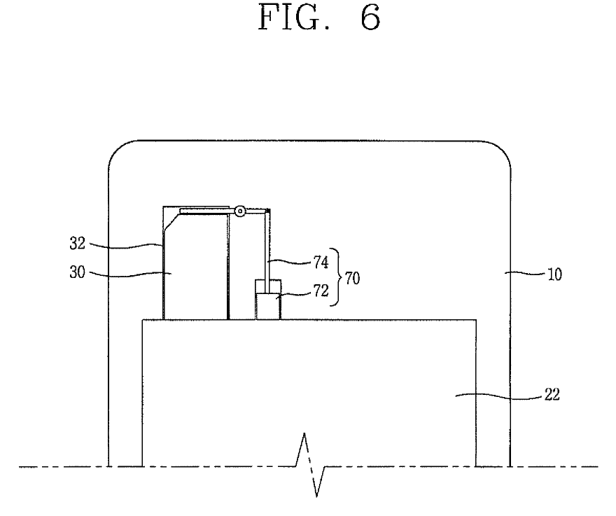

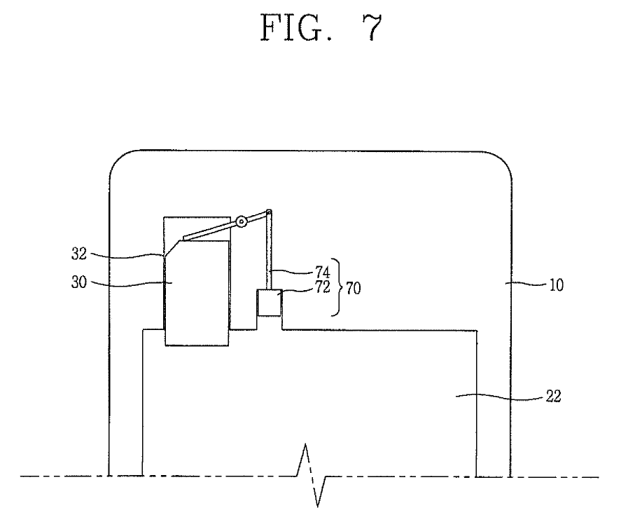

FIG. 6 is a sectional view of a mobile terminal according to a third aspect, and FIG. 7 shows an operational state of the mobile terminal according to the third aspect. The terminal according to the third aspect includes the terminal body 10 having the battery mounting part 22 on which the battery 20 is detachably mounted, the card receiving part 32 formed on one side of the battery mounting part 22 for receiving the card 30, and a button unit 70 for removing the card 30 from the card receiving part 32.

The card 30 and the card receiving part 32 of the mobile terminal according to the third are the same as those of the mobile terminal according to the first aspect, so its description will be omitted.

The button unit 70 includes a button 72 installed on one inner surface of the battery mounting part 22 and a withdrawing member 74 connected with a lower surface of the button 72. Pressing the button 72 moves the withdrawing member 74 and urges the card 30 from the card receiving part 32.

One end of the withdrawing member 74 is disposed at the lower surface of the button 72, the other end thereof is disposed at a rear side of the card receiving part 32, and a central portion is hinge-connected with the terminal body 10. When the button 72 is pressed, one end of the withdrawing member 74 is pressed, and accordingly, the other end of the withdrawing member 74 is rotated to push the rear surface of the card 30. The card 30 is urged from the card receiving part 32.

As so far described, the mobile terminal according to the present invention has the advantages that the card may be removed easily after the battery is removed from the terminal. The card is urged from the card receiving part by either an elastic member or a withdrawing member so that the user easily may remove the card completely. The card is held securely in the card receiving part by either the battery or by a locking rod.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a battery mounting part formed on a terminal body receiving a battery;
a card receiving part formed on the battery mounting part receiving a card; and
a card removal unit installed on the card receiving part wherein the card removal unit urges the card from the card receiving part when the battery is removed from the battery mounting part.

2. The terminal of claim 1, wherein the card removal unit comprises an elastic member providing an urging force in a direction that the card is removed.

3. The terminal of claim 2, wherein when the card is inserted in the card receiving part, one side of the card is supported on a surface of the battery and an opposing side is supported by the elastic member.

4. The terminal of claim 2, wherein the card removal unit further comprises a plate spring disposed on the card receiving unit and contacting with one surface of the card.

5. The terminal of claim 4, wherein the plate spring further comprises.
a fixed part disposed on the terminal body; and
an elastically supporting part extending from the fixed part and elastically supporting one surface of the card.

6. The terminal of claim 4, wherein the spring plate is disposed on one side of the card receiving unit.

7. The terminal of claim 3 further comprising:
a locking unit installed on the terminal body securing the card in the card receiving part.

8. The terminal of claim 7, wherein the elastic member is a plate spring.

9. The terminal of claim 7, wherein the locking unit comprises:
a locking rod slidably mounted on the battery mounting part wherein the locking rod is in one of a closed position and an open position; and
a spring urging the locking rod to the closed position.

10. The terminal of claim 9, wherein the locking rod is slidably mounted on one wall surface of the battery mounting part.

11. The terminal of claim 9, wherein the locking rod comprises a slope portion and a protrusion;
wherein the slope portion engages the card when the card is inserted into the card receiving part and urges the locking rod into the open position against the urging force of the spring;
wherein when the card is completely inserted into the card receiving part, the slope portion disengages from the card; and
wherein when the card is completely inserted into the card receiving part, the spring urges the locking rod into the closed position thereby retaining the card in the card receiving part.

12. The terminal of claim 11, wherein the protrusion is manually operated to urge the locking rod into the open position thereby enabling the card removal unit to urge the card from the card receiving part.

13. The terminal of claim 7, wherein the locking unit is installed on one side of the terminal body

14. The terminal of claim 1, wherein the card receiving part is formed on one side of the battery mounting part.

15. The terminal of claim 1, wherein the card removal unit is installed on one side of the card receiving part.

16. A mobile terminal comprising:
a battery mounting part formed on a rear surface of a terminal body receiving a battery;
a card receiving part formed on one side of the battery mounting part receiving a card; and
a button unit mounted on one side of the battery mounting part urging the card from the card receiving part.

17. The terminal of claim 16, wherein the button unit comprises:
a button mounted on one wall surface of the battery mounting part; and
a withdrawal member connected to the button and urges the card from the card receiving part when the button is pushed.

18. The terminal of claim 17, wherein one end of the withdrawing member contacts with a rear surface of the button, the other end of the withdrawing member contacts with the rear surface of the card, and a central portion of the withdrawal member is hinge-connected to an inner surface of the terminal body.

19. The terminal of claim 16, wherein the battery mounting part is formed on a rear surface of the terminal body.

20. The terminal of claim 16, wherein the card receiving part is formed on one side of the battery mounting part.
